(19) United States
(12) Patent Application Publication
(10) Pub. No.: US 2012/0105378 A1
(43) Pub. Date: May 3, 2012

(54) INPUT APPARATUS AND METHOD OF CONTROLLING THE SAME

(75) Inventors: Takuya OGISHIMA, Shizuoka-ken (JP); Sadatoshi OISHI, Shizuoka-ken (JP); Yuishi TAKENO, Shizuoka-ken (JP)

(73) Assignee: TOSHIBA TEC KABUSHIKI KAISHA, Tokyo (JP)

(21) Appl. No.: 13/286,714

(22) Filed: Nov. 1, 2011

Related U.S. Application Data
(60) Provisional application No. 61/409,928, filed on Nov. 3, 2010.

(51) Int. Cl. G06F 3/042

(52) U.S. Cl. 345/175

(57) ABSTRACT

According to one embodiment, an input apparatus comprises an input detector, a vibration detector, a controller, and a sensitivity adjustment unit. The input detector detects an input by the blockage of a light beam to scan a scan region. The vibration detector detects a vibration equal to or more than a set sensitivity applied to the input detector. The controller stops the light beam scanning when the input detector detects no inputs for a given length of time. The controller restores the light beam scanning when the vibration detector detects a vibration. The sensitivity adjustment unit changes the sensitivity of the vibration detector to be weaker than the set sensitivity when the input detector detects no inputs and the vibration detector continuously detects vibrations after the controller has restored the light beam scanning.

### CROSS-REFERENCE TO RELATED APPLICATIONS

This application is based upon and claims the benefit of priority from prior Japanese Patent Application 61/409,928, filed on Nov. 3, 2010, the entire contents of which are incorporated herein by reference.

### FIELD

Embodiments described herein relate generally to an input apparatus that uses a vibration sensor, and a method of controlling the same.

### BACKGROUND

An optical touch panel is known as a kind of input apparatus that uses a vibration sensor. When no inputs are performed for a given length of time, the optical touch panel stops light beam scanning and then enters a power saving mode. When a vibration equal to or more than a preset level is applied to the touch panel, the vibration sensor outputs a detection signal. In response to the detection signal from the vibration sensor, the optical touch panel in the power saving mode restores the light beam scanning to cancel the power saving mode. Thus, if a user moves the touch panel to use the touch panel in the power saving mode, the power saving mode is instantaneously canceled to enable input.

However, if vibrations contrary to user's intention are always applied to the optical touch panel, the vibration sensor continuously outputs detection signals. Therefore, even if no inputs are performed for a given length of time, the optical touch panel does not move to the power saving mode, and is always in the light beam scanning state.

### BRIEF DESCRIPTION OF THE DRAWINGS

FIG. 1 is a block diagram showing the overall configuration of an input apparatus according to one embodiment;

FIG. 2 is a flowchart showing a processing routine to be performed in accordance with an input control program by a CPU of the input apparatus according to the embodiment; and

FIG. 3 is a timing chart wherein a vibration is applied to the input apparatus according to the embodiment.

### DETAILED DESCRIPTION

In general, according to one embodiment, an input apparatus comprises an input detector, a vibration detector, a controller, and a sensitivity adjustment unit. The input detector detects an input by the blockage of a light beam to scan a scan region. The vibration detector detects a vibration equal to or more than a set sensitivity applied to the input detector. The controller stops the light beam scanning when the input detector detects no inputs for a given length of time. The controller restores the light beam scanning when the vibration detector detects a vibration. The sensitivity adjustment unit changes the sensitivity of the vibration detector to be weaker than the set sensitivity when the input detector detects no inputs and the vibration detector continuously detects vibrations after the controller has restored the light beam scanning.

Hereinafter, an embodiment of an input apparatus that uses an infrared optical touch panel as an input detector will be described. The input apparatus 1 has a power saving mode that stops light beam scanning to hold down power consumption when no inputs are performed for a given length of time. The input apparatus 1 comprises a vibration sensor 30 as a trigger to cancel the power saving mode.

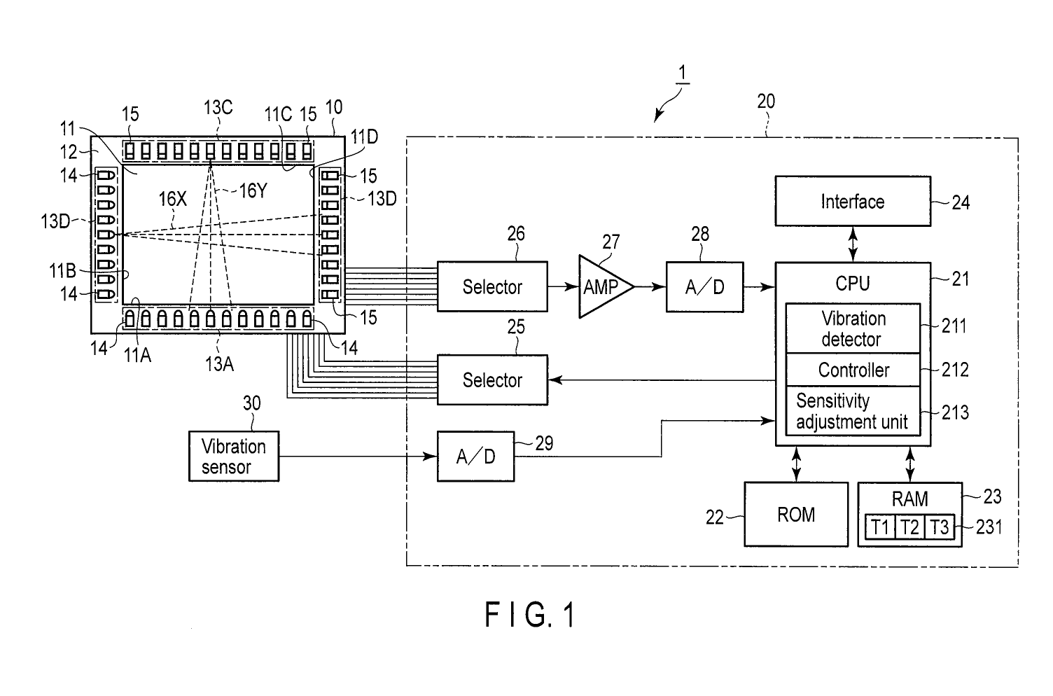

FIG. 1 is a block diagram showing the overall configuration of the input apparatus 1. The input apparatus 1 includes an input detector 10, a control box 20, and the vibration sensor 30. The input detector 10 is attached to one surface of the control box 20, and is combined with the control box 20. The vibration sensor 30 detects the vibration of the input detector 10 combined with the control box 20.

The input detector 10 includes a rectangular panel 11, and a touch ring 12 disposed on the outer peripheral portion of the panel 11. The panel 11 is a transparent acrylic plate or a reinforced glass plate, and is disposed on a screen such as a liquid crystal display (LCD) or a cathode ray tube (CRT). The screen of the LCD or the CRT may be directly used as the panel 11.

The touch ring 12 arranges light-emitting portions 13A and 13B along a first side 11A which is one side of the panel 11 and a second side 11B perpendicular to the first side 11A. The touch ring 12 also arranges light-receiving portions 13C and 13D along a third side 11C which faces the first side 11A of the panel 11 and a fourth side 11D which faces the second side 11B.

The light-emitting portions 13A and 13B align LEDs 14 which are light-emitting elements at substantially regular intervals along the sides 11A and 11B of the panel 11. Infrared LEDs which emit infrared light are used as the LEDs 14. The light-receiving portions 13C and 13D align photosensors 15 which are light-receiving elements equal in number to the light-emitting elements at substantially regular intervals along the sides 11C and 11D of the panel 11.

Accordingly, the LEDs 14 of the first light-emitting portion 13A face the photosensors 15 of the first light-receiving portion 13C one to one. Similarly, the LEDs 14 of the second light-emitting portion 13B face the photosensors 15 of the second light-receiving portion 13D one to one.

In the input detector 10 having such a configuration, the infrared light emanating from one LED 14 is received by at least the photosensor 15 facing this LED 14. Therefore, light beams 16A and 16B are formed on the panel 11 across each other.

In this condition, if a user touches the panel 11, part of the light beam 16A formed between the first light-emitting portion 13A and the first light-receiving portion 13C and part of the light beam 16B formed between the second light-emitting portion 13B and the second light-receiving portion 13D are blocked. A light-blocking position where the light beam 16A is blocked is input as X coordinates to the input detector 10. Similarly, a light-blocking position where the light beam 16B is blocked is input as Y coordinates to the input detector 10.

The control box 20 includes a central processing unit (CPU) 21, a read only memory (ROM) 22, a random access memory (RAM) 23, an interface 24, a light-emitting element selector 25, a light-receiving element selector 26, an amplifier 27, a first analog/digital (A/D) converter 28, and a second A/D converter 29. Although not shown, the interface 24 is connected to a host computer via a network.

The selector 25 individually selects the LEDs 14 arranged in the touch ring 12, and outputs a drive signal. The LED 14 which has received the drive signal emits infrared light.

The selector 26 individually selects the photosensors 15 arranged in the touch ring 12. The selector 26 then takes in a sensor signal of the selected photosensor 15, and outputs the sensor signal to the amplifier 27. The amplifier 27 amplifies the sensor signal, and outputs the amplified sensor signal to the first A/D converter 28. The first A/D converter 28 converts the amplified sensor signal to digital data, and outputs the digital data to the CPU 21.

The second A/D converter 29 converts the sensor signal of the vibration sensor 30 to digital data, and outputs the digital data to the CPU 21.

Fixed data such as a program is stored in the ROM 22. One program stored in this ROM 22 is an input control program. The CPU 21 executes this input control program to enable functions as a vibration detector 211, a controller 212, and a sensitivity adjustment unit 213.

The vibration detector 211 detects a vibration equal to or more than the set sensitivity applied to the input detector 10, in accordance with the sensor signal of the vibration sensor 30 and threshold data for the set sensitivity.

The controller 212 stops scanning with the light beams 16A and 16B when the input detector 10 detects no inputs for a given length of time. The controller 212 restores the scanning with the light beams 16A and 16B when the vibration detector 211 detects a vibration.

The sensitivity adjustment unit 213 changes the sensitivity of the vibration detector 211 to be weaker than the set sensitivity when the input detector 10 detects no inputs and the vibration detector 211 continuously detects vibrations after the controller 212 has restored the scanning with the light beams 16A and 16B. When the controller 212 stops the scanning with the light beams 16A and 16B, the sensitivity adjustment unit 213 returns the sensitivity of the vibration detector 211 to the set sensitivity accordingly.

The RAM 23 has various memory areas for temporarily storing variable data. A timer counter 231 is located in one of the memory areas. The timer counter 231 includes a first timer T1, a second timer T2, and a third timer T3.

The first timer T1 clocks a period of time that has elapsed since the restoration of the scanning with the light beams 16A and 16B. The second timer T2 clocks a period of time that has elapsed since the change of the sensitivity of the vibration detector 211. The third timer T3 clocks a period of time that has elapsed since the sensitivity adjustment unit 213 has judged that no vibration has been detected as a result of checking whether the vibration detector 211 has detected any vibration.

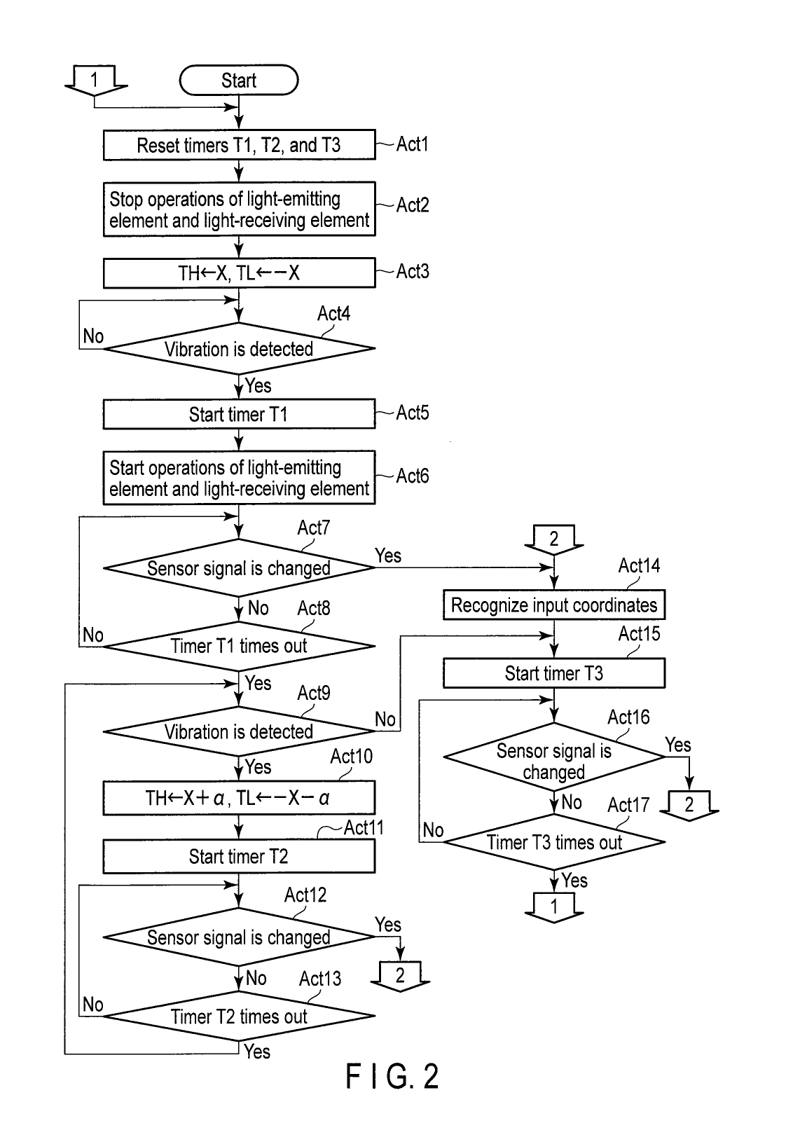

When the input control program is started, the CPU 21 starts a processing routine shown in the flowchart of FIG. 2. First, the CPU 21 resets the values of the timers T1, T2, and T3 of the timer counter 231 to “0” (Act 1). The CPU 21 also instructs the selector 25 and the selector 26 to stop the output of the drive signal (Act 2).

The CPU 21 brings a positive threshold TH set in the vibration detector 211 to a value corresponding to a set sensitivity K. The CPU 21 also brings a negative threshold TL set in the vibration detector 211 to a value corresponding to a set sensitivity −K (Act 3). The set sensitivities K and −K are stored in the ROM 22 in advance. The CPU 21 converts the set sensitivities K and −K to threshold data TH and TL at vibration judgment levels, and sets threshold data TH and TL in the vibration detector 211.

The CPU 21 judges whether the vibration detector 211 has detected any vibration (Act 4). The vibration detector 211 takes in a sensor signal of the vibration sensor 30 as digital data via the second A/D converter 29. The vibration detector 211 then compares the sensor signal with the positive or negative threshold data TH or TL. If the sensor signal is found to be beyond the threshold data TH or TL by the comparison, the vibration detector 211 outputs a detection pulse. That is, in the processing of Act 4, the CPU 21 examines whether the vibration detector 211 is outputting the detection pulse. If the vibration detector 211 is not outputting the detection pulse (NO in Act 4), the CPU 21 continues to monitor the vibration detector 211.

If a detection pulse is output from the vibration detector 211 (YES in Act 4), the CPU 21 starts the first timer T1 (Act 5). The CPU 21 also instructs the selector 25 and the selector 26 to start the output of the drive signal (Act 6).

In response to the instruction, the selector 25 individually selects the LEDs 14 arranged in the first and second light-emitting portions 13A and 13B, and outputs a drive signal. The selector 26 individually selects the photosensors 15 arranged in the first and second light-receiving portions 13C and 13D, and takes in sensor signals. The sensor signal of each photosensor 15 is amplified by the amplifier 27, and converted to digital data by the first A/D converter 28, and then taken in by the CPU 21.

The CPU 21 judges whether the waveform of the sensor signal of each photosensor 15 is changed by the blockage of the light beam (Act 7). When the waveform is not changed (NO in Act 7), the CPU 21 judges whether the first timer T1 has timed out (Act 8). When the first timer T1 has not timed out (NO in Act 8), the CPU 21 waits for the waveform of the sensor signal to be changed or waits for the first timer T1 to time out.

If the first timer T1 times out without the detection of any change of the sensor signal (YES in Act 8), the CPU 21 judges whether the vibration detector 211 has detected any vibration (Act 9). When a vibration is again detected in the processing of Act 9 after the processing of Act 4 (YES in Act 9), the CPU 21 changes the positive threshold TH set in the vibration detector 211 to increase by a level α, that is, to decrease the sensitivity of the vibration detection. The CPU 21 also changes the negative threshold TL to decrease by a level α, that is, to decrease the sensitivity of the vibration detection (Act 10).

Subsequently, the CPU 21 starts the second timer T2 (Act 11). The CPU 21 then judges whether the waveform of the sensor signal of each photosensor 15 is changed by the blockage of the light beam (Act 12). When the waveform is not changed (NO in Act 12), the CPU 21 judges whether the second timer T2 has timed out (Act 13). When the second timer T2 has not timed out (NO in Act 13), the CPU 21 waits for the waveform of the sensor signal to be changed or waits for the second timer T2 to time out.

If the second timer T2 times out without the detection of any change of the sensor signal (YES in Act 13), the CPU 21 moves back to the processing of Act 9 and judges whether the vibration detector 211 has detected any vibration. When a vibration is detected (YES in Act 9), the CPU 21 changes the positive threshold TH set in the vibration detector 211 to further increase by a level α. The CPU 21 also changes the negative threshold TL to further decrease by a level α (Act 10). Subsequently, the CPU 21 restarts the second timer T2 (Act 11).

When the waveform of the sensor signal is changed in the processing of Act 7 or Act 12 (YES in Act 7 or Act 12), the CPU 21 analyzes the sensor signal, and thus recognizes the values of X coordinates and Y coordinates on the panel 11. The CPU 21 outputs data for the recognized X coordinates and Y coordinates to the host computer via the interface 24 (Act 14).

The CPU 21 starts the third timer T3 (Act 15). The CPU 21 judges whether the waveform of the sensor signal of each photosensor 15 is changed by the blockage of the light beam (Act 16). When the waveform is not changed (NO in Act 16), the CPU 21 judges whether the third timer T3 has timed out (Act 17). When the third timer T3 has not timed out (NO in Act 17), the CPU 21 waits for the waveform of the sensor signal to be changed or waits for the third timer T3 to time out.

When the waveform of the sensor signal is changed before the third timer T3 times out (YES in Act 16), the CPU 21 analyzes the sensor signal, and thus recognizes the values of X coordinates and Y coordinates on the panel 11. The CPU 21 outputs data for the recognized X coordinates and Y coordinates to the host computer via the interface 24 (Act 14). Subsequently, the CPU 21 again starts the third timer T3 (Act 15).

Furthermore, in the processing of Act 16, the CPU 21 repeats the processing of Act 14 and Act 15 whenever the waveform of the sensor signal is changed.

If the third timer T3 has timed out in the processing of Act 17 (YES in Act 17), the CPU 21 moves back to the processing of Act 1. That is, the CPU 21 resets the values of the timers T1, T2, and T3 of the timer counter 231 to “0” (Act 1). The CPU 21 also instructs the selector 25 and the selector 26 to stop the output of the drive signal (Act 2).

In response to the instruction, the selector 25 stops the drive signal output to each of the LEDs 14. The selector 26 stops taking in the sensor signal from each of the photosensors 15. That is, the input apparatus 1 enters the power saving mode for stopping beam scanning to hold down power consumption.

At the same time, the CPU 21 returns the positive threshold TH set in the vibration detector 211 to the value corresponding to the set sensitivity K. The CPU 21 also returns the negative threshold TL set in the vibration detector 211 to the value corresponding to the set sensitivity −K (Act 3).

Subsequently, the CPU 21 waits for the vibration detector 211 to detect a vibration (Act 4). When a vibration is detected, the CPU 21 starts the first timer T1 (Act 5). The CPU 21 also instructs the selector 25 and the selector 26 to start the output of the drive signal (Act 6). That is, the power saving mode is canceled.

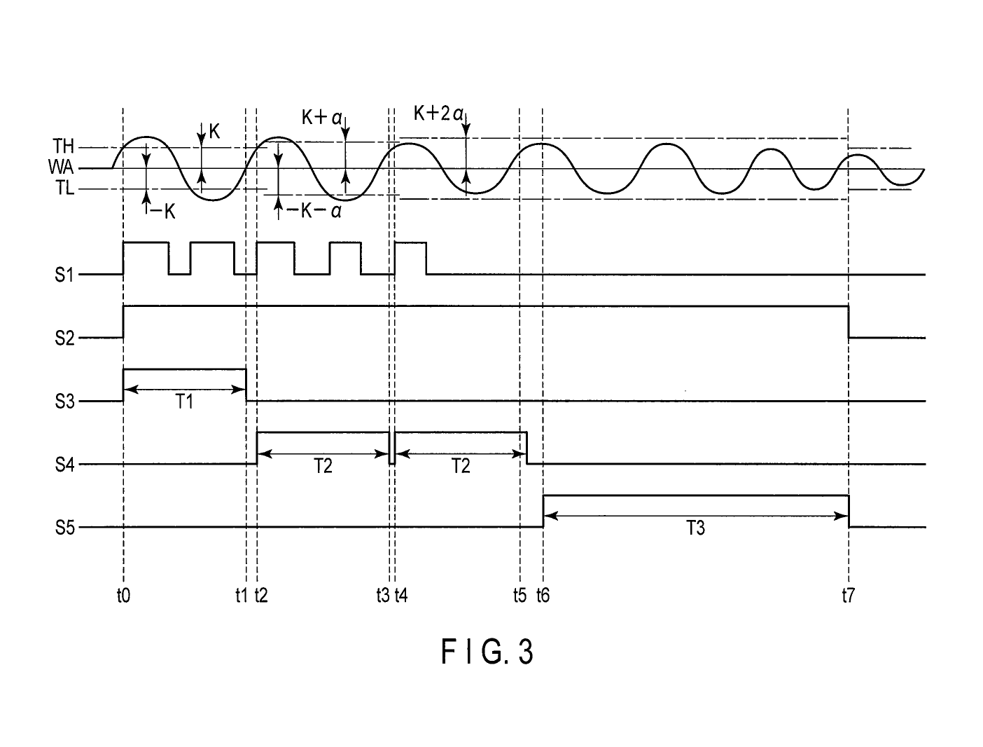

FIG. 3 is a timing chart showing a detection pulse signal S1, a drive signal S2 output from the selectors 25 and 26, an output signal S3 of the first timer T1, an output signal S4 of the second timer T2, and an output signal S5 of the third timer T3 when a vibration waveform WA is detected by the vibration sensor 30. Suppose that the waveform of the sensor signal of each photosensor 15 is not changed by the blockage of the light beam in a period shown in FIG. 3.

At a time t0, the detection pulse signal S1 turns on if the vibration waveform WA exceeds the positive threshold TH at the vibration judgment level. When the signal S1 turns on, the drive signal S2 is output from the selectors 25 and 26 accordingly. The first timer T1 is also started.

If the detection pulse signal S1 turns on within a predetermined time at the time t1 after the first timer T1 has timed out, the second timer T2 is started at a time t2. At the same time, the positive threshold TH at the vibration judgment level increases by a level α. The negative threshold TL also decreases by a level α. If the detection pulse signal S1 turns on within a predetermined time at the time t3 after the second timer T2 has timed out, the second timer T2 is again started at a time t4. At the same time, the positive threshold TH at the vibration judgment level further increases by a level α. The negative threshold TL also further decreases by a level α.

If the detection pulse signal S1 does not turn on within a predetermined time at a time t5 after the second timer T2 has timed out, the third timer T3 is started at a time t6. If the third timer T3 times out without any change of the sensor signal at a time t7, the output of the drive signal S2 is stopped.

As described above, in the input apparatus 1 according to the present embodiment, if the input detector 10 detects no inputs for a given length of time, the light beams 16A and 16B for scanning the space between the LED 14 and the photosensor 15 are stopped, and the input apparatus 1 enters the power saving mode. When the vibration detector 211 detects a vibration equal to or more than the set sensitivity corresponding to the threshold ±K, the light beam scanning is restored, and the power saving mode is canceled.

Here, a vibration applied to the input apparatus 1 may be a vibration contrary to user's intention, and this vibration may not converge immediately. In this case, conventionally, the input apparatus 1 does not enter the power saving mode because a vibration equal to or more than the set sensitivity is detected even if the input detector 10 detects no inputs for a given length of time.

In contrast, in the input apparatus 1 according to the present embodiment, the sensitivity of the vibration detector 211 is changed to be weaker than the set sensitivity. As a result, the vibration detector 211 does not detect any vibration, and the input apparatus 1 therefore enters the power saving mode. This makes it possible to provide an advantageous effect of the reduction of power consumption attributed to the power saving mode. The power saving enables a longer life of the LED.

Now, an alternative embodiment of the input apparatus 1 is described.

In the previously described embodiment, the sensitivity of the vibration detector 211 is always changed to be weaker than the set sensitivity by the fixed level α. In the alternative embodiment, the level α increases or decreases with the number of changes.

In the previously described embodiment, there are provided the first timer T1 for clocking a period of time that has elapsed since the restoration of the light beam scanning, and the second timer T2 for clocking a period of time that has elapsed since the change of the sensitivity of the vibration detector 211. In the alternative embodiment, the first timer and the second timer T2 are unified.

In the previously described embodiment, when the controller 212 stops the light beam scanning, the sensitivity of the vibration detector 211 is returned to the set sensitivity accordingly. In the alternative embodiment, even if the controller 212 stops the light beam scanning, the sensitivity of the vibration detector 211 is not returned to the set sensitivity. The sensitivity of the vibration detector 211 is maintained until the input apparatus 1 is powered off. When the input apparatus is powered on, the sensitivity of the vibration detector 211 is returned to the set sensitivity in initialization processing at the same time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An input apparatus comprising:
an input detector which detects an input by the blockage of a light beam to scan a scan region;
a vibration detector which detects a vibration equal to or more than a set sensitivity applied to the input detector;
a controller which stops the light beam scanning when the input detector detects no inputs for a given length of time, and restores the light beam scanning when the vibration detector detects a vibration; and
a sensitivity adjustment unit which changes the sensitivity of the vibration detector to be weaker than the set sensitivity when the input detector detects no inputs and the vibration detector continuously detects vibrations after the controller has restored the light beam scanning.

2. The apparatus of claim 1, wherein
when the controller stops the light beam scanning, the sensitivity adjustment unit returns the sensitivity of the vibration detector to the set sensitivity accordingly.

3. The apparatus of claim 1, further comprising:
a first timer which clocks a period of time that has elapsed since the restoration of the light beam scanning,
wherein the sensitivity adjustment unit checks whether the vibration detector has detected any vibration when the input detector detects no inputs before the first timer times out, and the sensitivity adjustment unit changes the sensitivity of the vibration detector to be weaker than the set sensitivity when the vibration detector has detected a vibration.

4. The apparatus of claim 3, further comprising:
a second timer which clocks a period of time that has elapsed since the change of the sensitivity of the vibration detector,
wherein the sensitivity adjustment unit checks whether the vibration detector has detected any vibration when the input detector detects no inputs before the second timer times out, and the sensitivity adjustment unit changes the sensitivity of the vibration detector to be weaker than the set sensitivity when the vibration detector has detected a vibration.

5. The apparatus of claim 3, further comprising:
a third timer which clocks a period of time that has elapsed since the sensitivity adjustment unit has judged that no vibration has been detected as a result of checking whether the vibration detector has detected any vibration,
wherein the controller stops the light beam scanning when the input detector detects no inputs before the third timer times out.

6. The apparatus of claim 5, wherein
when the controller stops the light beam scanning, the sensitivity adjustment unit returns the sensitivity of the vibration detector to the set sensitivity accordingly.

7. The apparatus of claim 4, further comprising:
a third timer which clocks a period of time that has elapsed since the sensitivity adjustment unit has judged that no vibration has been detected as a result of checking whether the vibration detector has detected any vibration,
wherein the controller stops the light beam scanning when the input detector detects no inputs before the third timer times out.

8. The apparatus of claim 7, wherein
when the controller stops the light beam scanning, the sensitivity adjustment unit returns the sensitivity of the vibration detector to the set sensitivity accordingly.

9. An input apparatus comprising:
an input detector which detects an input by the blockage of a light beam to scan a space between a light-emitting element and a light-receiving element that are disposed to face each other across a scan region;
a vibration detector which detects a vibration equal to or more than a set sensitivity applied to the input detector;
a controller which stops the operations of the light-emitting element and the light-receiving element when the input detector detects no inputs for a given length of time, and restores the operations of the light-emitting element and the light-receiving element when the vibration detector detects a vibration; and
a sensitivity adjustment unit which changes the sensitivity of the vibration detector to be weaker than the set sensitivity when the input detector detects no inputs and the vibration detector continuously detects vibrations after the controller has restored the operations of the light-emitting element and the light-receiving element.

10. The apparatus of claim 9, wherein
when the controller stops the operations of the light-emitting element and the light-receiving element, the sensitivity adjustment unit returns the sensitivity of the vibration detector to the set sensitivity accordingly.

11. The apparatus of claim 9, further comprising:
a first timer which clocks a period of time that has elapsed since the restoration of the operations of the light-emitting element and the light-receiving element,
wherein the sensitivity adjustment unit checks whether the vibration detector has detected any vibration when the input detector detects no inputs before the first timer times out, and the sensitivity adjustment unit changes the sensitivity of the vibration detector to be weaker than the set sensitivity when the vibration detector has detected a vibration.

12. The apparatus of claim 11, further comprising:
a second timer which clocks a period of time that has elapsed since the change of the sensitivity of the vibration detector,
wherein the sensitivity adjustment unit checks whether the vibration detector has detected any vibration when the input detector detects no inputs before the second timer times out, and the sensitivity adjustment unit changes the sensitivity of the vibration detector to be weaker than the set sensitivity when the vibration detector has detected a vibration.

13. The apparatus of claim 11, further comprising:
a third timer which clocks a period of time that has elapsed since the sensitivity adjustment unit has judged that no vibration has been detected as a result of checking whether the vibration detector has detected any vibration,
wherein the controller stops the operations of the light-emitting element and the light-receiving element when the input detector detects no inputs before the third timer times out.

14. The apparatus of claim 13, wherein
when the controller stops the operations of the light-emitting element and the light-receiving element, the sensitivity adjustment unit returns the sensitivity of the vibration detector to the set sensitivity accordingly.

15. The apparatus of claim 12, further comprising:
a third timer which clocks a period of time that has elapsed since the sensitivity adjustment unit has judged that no vibration has been detected as a result of checking whether the vibration detector has detected any vibration,
wherein the controller stops the operations of the light-emitting element and the light-receiving element when the input detector detects no inputs before the third timer times out.

16. The apparatus of claim 15, wherein
when the controller stops the operations of the light-emitting element and the light-receiving element, the sensitivity adjustment unit returns the sensitivity of the vibration detector to the set sensitivity accordingly.

17. A method of controlling an input apparatus, the input apparatus comprising an input detector which detects an input by the blockage of a light beam to scan a scan region, a vibration detector which detects a vibration equal to or more than a set sensitivity applied to the input detector, and a controller the method comprising:
causing the controller to stop the light beam scanning when the input detector detects no inputs for a given length of time;
causing the controller to restore the light beam scanning when the vibration detector detects a vibration; and
causing a sensitivity adjustment unit to change the sensitivity of the vibration detector to be weaker than the set sensitivity when the input detector detects no inputs and the vibration detector continuously detects vibrations after the controller has restored the light beam scanning.

18. The method of claim 17, wherein
when the controller stops the light beam scanning, the sensitivity adjustment unit returns the sensitivity of the vibration detector to the set sensitivity accordingly.

19. The method of claim 17, further comprising:
using a first timer to clock a period of time that has elapsed since the restoration of the light beam scanning,
wherein the sensitivity adjustment unit checks whether the vibration detector has detected any vibration when the input detector detects no inputs before the first timer times out, and the sensitivity adjustment unit changes the sensitivity of the vibration detector to be weaker than the set sensitivity when the vibration detector has detected a vibration.

20. The method of claim 19, further comprising:
using a second timer to clock a period of time that has elapsed since the change of the sensitivity of the vibration detector,
wherein the sensitivity adjustment unit checks whether the vibration detector has detected any vibration when the input detector detects no inputs before the second timer times out, and the sensitivity adjustment unit changes the sensitivity of the vibration detector to be weaker than the set sensitivity when the vibration detector has detected a vibration.
